(19) United States
(12) Patent Application Publication
(10) Pub. No.: US 2024/0303467 A1
(43) Pub. Date: Sep. 12, 2024

(54) LEARNING DEVICE AND TEST DEVICE FOR TRAINING STUDENT NEURAL NETWORK

(71) Applicants: Hyundai Motor Company, Seoul (KR); Kia Corporation, Seoul (KR)

(72) Inventors: Jae Hoon Cho, Seoul (KR); Jae Hyeon Park, Seoul (KR); Hyun Kook Park, Seoul (KR)

(21) Appl. No.: 18/507,548

(22) Filed: Nov. 13, 2023

(30) Foreign Application Priority Data
Jul. 3, 2023 (KR) 10-2023-0085837

(51) Int. Cl. G06N 3/045; G06N 3/084; G06V 10/776; G06V 10/778; G06V 10/82; G06V 20/70

(52) U.S. Cl. CPC G06N 3/045; G06N 3/084; G06V 10/776; G06V 10/7792; G06V 10/82; G06V 20/70

(57) ABSTRACT

Machine learning and testing devices are provided. The device applies a neural network operation of a first student neural network to a training image to generate first prediction information, applies a neural network operation of a second student neural network to generate second prediction information, applies an error identification operation to a first integrated image to generate first error identification prediction information, applies the error identification operation to a second integrated image to generate second error identification prediction information, applies a network operation of a first teacher neural network to the training image to generate first pseudo label information, applies a neural network operation of a second teacher neural network to the training image to generate second pseudo label information, back-propagates a loss and updates parameters of the first and second student neural networks.

### CROSS-REFERENCE TO RELATED APPLICATION

This application claims the benefit of priority to Korean Patent Application No. 10-2023-0085837, filed in the Korean Intellectual Property Office on Jul. 3, 2023, the entire contents of which are incorporated herein by reference.

### TECHNICAL FIELD

The present disclosure relates to a learning device for training a student neural network based on knowledge distillation using a plurality of teacher neural networks, a learning method therefor, a test device using the same, and a test method using the same.

### BACKGROUND

Recently, with the development of deep neural network-based computer vision technology in the field of autonomous driving, various artificial intelligence models have been researched, such as object detection, semantic segmentation, depth estimation, and lane detection.

For example, semantic segmentation is variously used to recognize surrounding situations and spaces for vehicles, lines, free spaces, and the like using cameras of an autonomous driving vehicle.

Furthermore, recently, the deep neural network-based computer vision technology has constructed large datasets including high-quality labels and have achieved marked improvement in performance by means of supervised learning using the large datasets.

However, because much cost, time, and manpower are needed to construct large training datasets with high-quality labels, the constructing training dataset stage may create a even before bottleneck in the workflow an artificial intelligence model could be trained in earnest.

Semi-supervised learning is proposed as a scheme for addressing the problem as noted above. Semi-supervised learning refers to a learning scheme that uses both labeled and unlabeled data.

A pseudo labeling scheme may be used with unlabeled data in such semi-supervised learning. A pseudo label may be generated through a neural network that is pre-trained using a large amount of training data.

However, because it is difficult to achieve perfect performance (e.g., perfect accuracy, etc.) in all aspects due to the nature of a neural network and the neural network is vulnerable to a specific characteristic (e.g., because the neural network is vulnerable to a local area and a wide receptive field), when a new neural network (e.g., a student neural network) is trained using a pseudo label generated by the neural network (e.g., a teacher neural network), the student neural network may have the same or similar vulnerability as the teacher neural network.

### SUMMARY

The present disclosure may solve the above-mentioned problems while keeping any advantages achieved intact.

An aspect of the present disclosure provides a learning device for training a student neural network based on knowledge distillation using a plurality of teacher neural networks, a learning method therefor, a test device using the same, and a test method using the same.

Another aspect of the present disclosure provides a learning device for delivering an advantage of each of a plurality of teacher neural networks to a student neural network, a learning method therefor, a test device using the same, and a test method using the same.

Another aspect of the present disclosure provides a learning device for reducing costs consumed to construct a training dataset, a learning method therefor, a test device using the same, and a test method using the same.

Another aspect of the present disclosure provides a learning device for improving the performance of a student neural network based on knowledge distillation between a plurality of student neural networks, a learning method therefor, a test device using the same, and a test method using the same.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a learning device may include: one or more processors; and memory. The memory may store instructions that, when executed by the one or more processors, cause the learning device to: apply a neural network operation of a first student neural network to a training image to generate first prediction information corresponding to a specific task; apply a neural network operation of a second student neural network to the training image to generate second prediction information corresponding to the specific task; apply, based on the first prediction information and the training image, an error identification operation of an error identification network to a first integrated image to generate first error identification prediction information for predicting accuracy of the first prediction information; apply, based on the second prediction information and the training image, the error identification operation of the error identification network to a second integrated image to generate second error identification prediction information for predicting accuracy of the second prediction information; apply a neural network operation of a first teacher neural network, associated with the first student neural network, to the training image to generate first pseudo label information corresponding to the specific task; apply a neural network operation of a second teacher neural network, associated with the second student neural network, to the training image to generate second pseudo label information corresponding to the specific task; back-propagate, using a parameter update device, a loss based on at least one of: the first prediction information, the second prediction information, the first error identification prediction information, the second error identification prediction information, the first pseudo label information, or the second pseudo label information; and update, using the parameter update device and based on the loss, parameters of the first student neural network and the second student neural network.

The loss may include a first loss, a second loss, and a third loss. The instructions, when executed by the one or more processors, may further cause the learning device to: generate the first loss based on the first prediction information, the first error identification prediction information, and the first pseudo label information; generate the second loss based on the second prediction information, the second error identification prediction information, and the second pseudo label information; and generate the third loss based on the first prediction information and the second prediction information.

The instructions, when executed by the one or more processors, may further cause the learning device to perform at least one of: generating, using the error identification network and based on a determination that the first prediction information is accurate, the first error identification information by determining a first specific value within a first certain range corresponding to a first identification value, or generating, using the error identification network and based on a determination that the first prediction information is inaccurate, the first error identification prediction information by determining a second specific value within a second certain range corresponding to a second identification value less than the first identification value. The instructions, when executed by the one or more processors, may further cause the learning device to perform at least one of: generating, using the error identification network and based on a determination that the second prediction information is accurate, the second error identification prediction information by determining a third specific value within the first certain range, or generating, using the error identification network and based on a determination that the second prediction information is inaccurate, the second error identification prediction information by determining a fourth specific value within the second certain range.

The instructions, when executed by the one or more processors, may further cause the learning device to: generate the first integrated image with a concatenation operation on the first prediction information and the training image; and generate the second integrated image with the concatenation operation on the second prediction information and the training image.

The specific task may include one of: a segmentation task, a depth estimation task, or an image restoration task.

According to one or more example embodiments of the present disclosure, a test device may include: one or more processors; and memory. The memory stores instructions that, when executed by the one or more processors, may cause the learning device to: apply a first neural network operation of a first student neural network to a training image to generate first prediction information corresponding to a specific task, wherein the first student neural network comprises a specific task neural network; apply a neural network operation of a second student neural network to the training image to generate second prediction information corresponding to the specific task; apply, based on the first prediction information and the training image, an error identification operation of an error identification network to a first integrated image to generate first error identification prediction information for predicting accuracy of the first prediction information; apply, based on the second prediction information and the training image, the error identification operation of the error identification network to a second integrated image to generate second error identification prediction information for predicting accuracy of the second prediction information; apply a neural network operation of a first teacher neural network, associated with the first student neural network, to the training image to generate first pseudo label information corresponding to the specific task; apply a neural network operation of a second teacher neural network, associated with the second student neural network, to the training image to generate second pseudo label information corresponding to the specific task; back-propagate, using a parameter update device, a first loss based on at least one of: the first prediction information, the second prediction information, the first error identification prediction information, the second error identification prediction information, the first pseudo label information, or the second pseudo label information; update, using the parameter update device and based on the first loss, parameters of the first student neural network and the second student neural network; receive, using a test image input device, a test image; and apply a specific neural network operation of the specific task neural network to the test image to generate prediction information for testing, the prediction information corresponding to the specific task.

The loss may include a first loss, a second loss, and a third loss. The instructions, when executed by the one or more processors, may further cause the learning device to: generate the first loss based on the first prediction information, the first error identification prediction information, and the first pseudo label information; generate the second loss based on the second prediction information, the second error identification prediction information, and the second pseudo label information; and generate the third loss based on the first prediction information and the second prediction information.

The instructions, when executed by the one or more processors, may further cause the learning device to perform at least one of: generating, using the error identification network and based on a determination that the first prediction information is accurate, the first error identification information by determining a first specific value within a first certain range corresponding to a first identification value, or generating, using the error identification network and based on a determination that the first prediction information is inaccurate, the first error identification prediction information by determining a second specific value within a second certain range corresponding to a second identification value less than the first identification value. The instructions, when executed by the one or more processors, may further cause the learning device to perform at least one of: generating, using the error identification network and based on a determination that the second prediction information is accurate, the second error identification prediction information by determining a third specific value within the first certain range, or generating, using the error identification network and based on a determination that the second prediction information is inaccurate, the second error identification prediction information by determining a fourth specific value within the second certain range.

The instructions, when executed by the one or more processors, may further cause the learning device to: generate the first integrated image with a concatenation operation on the first prediction information and the training image; and generate the second integrated image with the concatenation operation on the second prediction information and the training image.

The specific task may include one of: a segmentation task, a depth estimation task, or an image restoration task.

According to one or more example embodiments of the present disclosure, a method may include: applying a neural network operation of a first student neural network to a first training image to generate first prediction information corresponding to a specific task; applying a neural network operation of a second student neural network to the first training image to generate second prediction information corresponding to the specific task; applying, based on the first prediction information and the training image, an error identification operation of an error identification network to a first integrated image to generate first error identification prediction information for predicting accuracy of the first prediction information; applying, based on the second prediction information and the training image, the error identification operation of the error identification network to a second integrated image to generate second error identification prediction information for predicting accuracy of the second prediction information; applying a neural network operation of a first teacher neural network, associated with the first student neural network, to the first training image to generate first pseudo label information corresponding to the specific task; applying a neural network operation of a second teacher neural network, associated with the second student neural network, to the first training image to generate second pseudo label information corresponding to the specific task; back-propagating, using a parameter update device, a loss based on at least one of: the first prediction information, the second prediction information, the first error identification prediction information, the second error identification prediction information, the first pseudo label information, or the second pseudo label information; and updating, using the parameter update device and based on the loss, parameters of the first student neural network and the second student neural network.

Updating the parameters may include: back-propagating, using the parameter update device, the loss by:
generating a first loss based on the first prediction information, the first error identification prediction information, and the first pseudo label information;
generating a second loss based on the second prediction information, the second error identification prediction information, and the second pseudo label information; and
generating a third loss based on the first prediction information and the second prediction information.

The method of claim 11 may further include one of: generating, using the error identification network and based on a determination that the first prediction information is accurate, the first error identification information by determining a first specific value within a first certain range corresponding to a first identification value, or generating, using the error identification network and based on a determination that the first prediction information is inaccurate, the first error identification prediction information by determining a second specific value within a second certain range corresponding to a second identification value less than the first identification value. The method may further include one of: generating, using the error identification network and based on a determination that the second prediction information is accurate, the second error identification prediction information by determining a third specific value within the first certain range, or generating, using the error identification network and based on a determination that the second prediction information is inaccurate, the second error identification prediction information by determining a fourth specific value within the second certain range.

One of the first student neural network or the second student neural network is a specific student neural network. The method may further include, before generating the first prediction information and the second prediction information: applying, using the specific student neural network, a specific neural network operation to a second training image including specific label information corresponding to the specific task to generate specific prediction information corresponding to the specific task; back-propagating, using the parameter update device, a second loss based on the specific prediction information and the specific label information; and updating, using the parameter update device and based on the second loss, a parameter of the specific student neural network.

The method may further include, after updating the parameter of the specific student neural network: applying, using the error identification network and based on the specific prediction information and the second training image, the error identification operation to a specific integrated image to generate specific error identification prediction information for predicting accuracy of the specific prediction information; and back-propagating, using the parameter update device, a third loss based on the specific error identification prediction information and specific error identification label information corresponding to the specific error identification prediction information; and updating, using the parameter update device, a parameter of the error identification network.

According to an aspect of the present disclosure, a learning device may include a first student neural network that applies 1_1st neural network operation to a training image to generate first prediction information corresponding to a specific task, a second student neural network that applies 2_1st neural network operation to the training image to generate second prediction information corresponding to the specific task, an error identification network that applies error identification operation to a first integrated image based on the first prediction information and the training image to generate first error identification prediction information for predicting accuracy of the first prediction information and applies the error identification operation to a second integrated image based on the prediction information and the training image to generate second error identification prediction information for predicting accuracy of the second prediction information, a first teacher neural network that applies 1_2nd neural network operation to the training image to generate first pseudo label information corresponding to the specific task, a second teacher neural network that applies 2_2nd neural network operation to the training image to generate second pseudo label information corresponding to the specific task, and a parameter update device that back-propagates a first loss based on at least some of the first prediction information, the second prediction information, the first error identification prediction information, the second error identification prediction information, the first pseudo label information, or the second pseudo label information and updates parameters of the first student neural network and the second student neural network.

In an embodiment, the first loss may include a 1_1st loss, a 1_2nd loss, and a 1_3rd loss. The 1_1st loss may be generated based on the first prediction information, the first error identification prediction information, and the first pseudo label information, the 1_2nd loss may be generated based on the second prediction information, the second error label information, and the 1_3rd loss may be generated based on the first prediction information and the second prediction information.

In an embodiment, the error identification network may generate a first specific value within a first certain range corresponding to a first identification value as the first error identification prediction information, when the first prediction information is determined as being accurate, may generate a second specific value within a second certain range corresponding to a second identification value less than the first identification value as the first error identification prediction information, when the first prediction information is determined as being inaccurate, may generate a third specific value within the first certain range as the second error identification prediction information, when the second prediction information is determined as being accurate, and may generate a fourth specific value within the second certain range as the second error identification prediction information, when the second prediction information is determined as being inaccurate.

In an embodiment, the first integrated image may be generated as concatenation operation is applied to the first prediction information and the training image, and the second image may be generated as the concatenation integrated operation is applied to the second prediction information and the training image.

In an embodiment, the specific task may be any one of a segmentation task, a depth estimation task, or an image restoration task.

According to another aspect of the present disclosure, a test device may include a test image input device that receives a test image and a specific task neural network that applies specific neural network operation to the test image to generate prediction information for testing, the prediction information corresponding to a specific task.

According to another aspect of the present disclosure, a learning method may include applying, by a first student neural network, 1_1st neural network operation to a first training image to generate first prediction information corresponding to a specific task, applying, by a second student neural network, 2_1st neural network operation to the first training image to generate second prediction information corresponding to the specific task, applying, by an error identification network, error identification operation to a first integrated image based on the first prediction information and the first training image to generate first error identification prediction information for predicting accuracy of the first prediction information and applying, by the error identification network, the error identification operation to a second integrated image based on the second prediction information and the first training image to generate second error identification prediction information for predicting accuracy of the second prediction information, applying, by a first teacher neural network, 1_2nd neural network operation to the first training image to generate first pseudo label information corresponding to the specific task, applying, by a second teacher neural network, 2_2nd neural network operation to the first training image to generate second pseudo label information corresponding to the specific task, and back-propagating, by a parameter update device, a first loss based on at least some of the first prediction information, the second prediction information, the first error identification prediction information, the second error identification prediction information, the first pseudo label information, the second pseudo label information and updating, by the parameter update device, parameters of the first student neural network and the second student neural network.

In an embodiment, the updating of the parameters may include back-propagating, by the parameter update device, a 1_1st loss generated based on the first prediction information, the first error identification prediction information, and the first pseudo label information, a 1_2nd loss generated based on the second prediction information, the second error label information, and a 1_3rd loss generated based on the first prediction information and the second prediction information as the first loss and updating, by the parameter update device, the parameters of the first student neural network and the second student neural network.

In an embodiment, the generating of the first error identification prediction information and the second error identification prediction information may include generating, by the error identification network, a first specific value within a first certain range corresponding to a first identification value as the first error identification prediction information, when the first prediction information is determined as being accurate, generating, by the error identification network, a second specific value within a second certain range corresponding to a second identification value less than the first identification value as the first error identification prediction information, when the first prediction information is determined as being inaccurate, generating, by the error identification network, a third specific value within the first certain range as the second error identification prediction information, when the second prediction information is determined as being accurate, and generating, by the error identification network, a fourth specific value within the second certain range as the second error identification prediction information, when the second prediction information is determined as being inaccurate.

In an embodiment, the learning method may further include, before generating the first prediction information and the second prediction information, applying, by a specific student neural network between the first student neural network and the second student neural network, specific neural network operation to a second training image including specific label information corresponding to the specific task to generate specific prediction information corresponding to the specific task and back-propagating, by the parameter update device, a second loss based on the specific prediction information and the specific label information and updating, by the parameter update device, a parameter of the specific student neural network.

In an embodiment, the learning method may further include, after updating the parameter of the specific student neural network, applying, by the error identification network, the error identification operation to a specific integrated image based on the specific prediction information and the second training image to generate specific error identification prediction information for predicting accuracy of the specific prediction information and back-propagating, by the parameter update device, a third loss based on the specific error identification prediction information and specific error identification label information corresponding to the specific error identification prediction information and updating, by the parameter update device, a parameter of the error identification network.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a learning device;

FIGS. 2, 3, 4A, 4B, 5, and 6 are drawings for describing an operation of a learning device;

FIG. 7 is a flowchart for describing a learning method;

FIG. 8 is a block diagram illustrating a configuration of a test device;

FIG. 9 is a drawing for describing an operation of a test device; and

FIGS. 10A and 10B are drawings comparing an output of a test device with an output of a device.

With regard to description of drawings, the same or similar denotations may be used for the same or similar components.

### DETAILED DESCRIPTION

Hereinafter, one or more example embodiments of the present disclosure will be described in detail with reference to the accompanying drawings. In adding the reference numerals to the components of each drawing, it should be noted that the identical component is designated by the identical numerals even when they are displayed on other drawings. Further, in describing the example embodiment (s) of the present disclosure, a detailed description of well-known features or functions will be ruled out in order not to unnecessarily obscure the gist of the present disclosure.

In describing the components of the example embodiment (s) according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

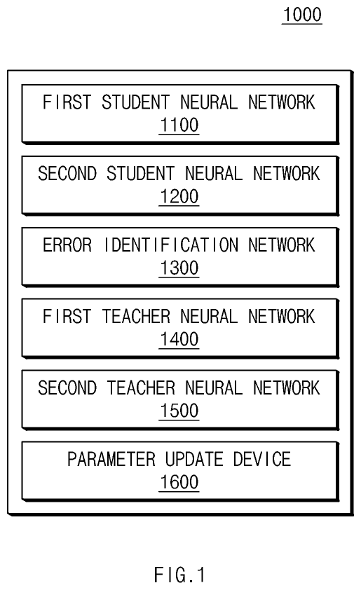

Hereinafter, one or more example embodiments of the present disclosure will be described in detail with reference to FIGS. 1 to 10B.

FIG. 1 is a block diagram illustrating a configuration of a learning (e.g., machine learning) device 1000.

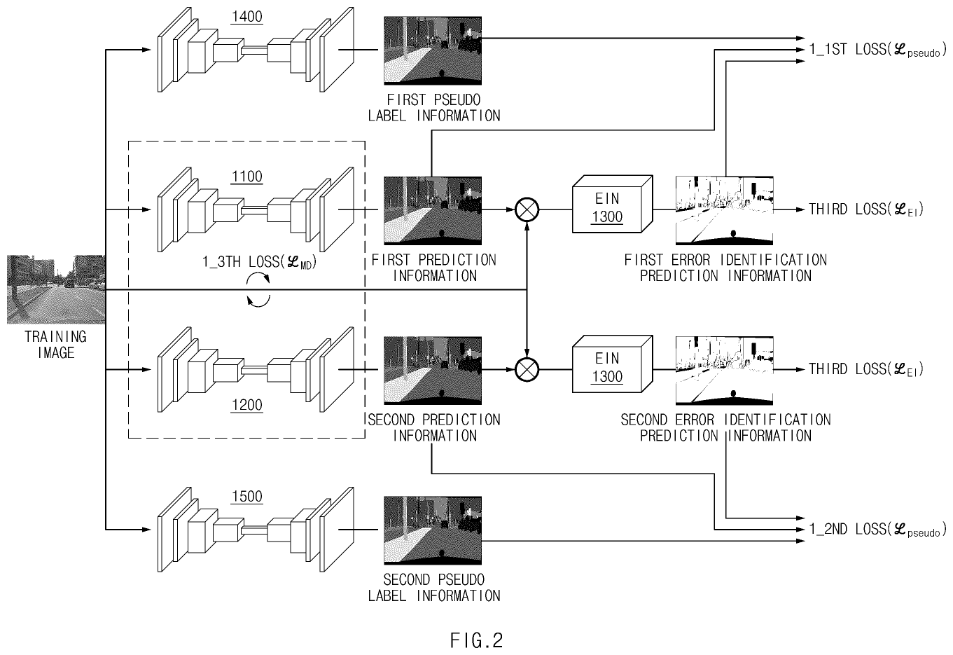

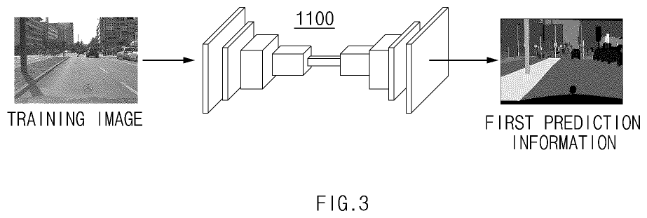

Referring to FIG. 1, the learning device 1000 may include a first student neural network 1100, a second student neural network 1200, an error identification network 1300, a first teacher neural network 1400, a second teacher neural network 1500, and a parameter update device 1600. This will be described in detail with reference to FIGS. 2 to 6. For reference, a duplicated description of the same/similar portion to a description of each of the first student neural network 1100 and the first teacher neural network 1400 will be omitted in the description of each of the second student neural network 1200 and the second teacher neural network 1500. Only the first student neural network 1100 and/or the first teacher neural network 1400 are illustrated for convenience in FIGS. 3 to 5.

One or more example components shown in FIG. 1 may implemented with software, hardware, or a combination or both. For example, one or more example components shown in FIG. 1 may be implemented with a computing system.

The computing system may include at least one processor, memory, a user interface input device, a user interface output device, storage, and/or a network interface connected via a bus.

The processor may be a central processing unit (CPU) or a semiconductor device that performs processing on commands stored in the memory and/or the storage. The memory and the storage may include various types of volatile or non-volatile storage media. For example, the memory may include a read-only memory (ROM) and a random access memory (RAM).

Thus, the operations of the method or the algorithm described herein may be embodied directly in hardware or a software module executed by the processor, or in a combination thereof. The software module may reside on a storage medium (that is, the memory and/or the storage) such as RAM, flash memory, ROM, erasable programmable ROM (EPROM), electrically erasable programmable ROM (EEPROM), a register, a hard disk, a removable disk, and/or a compact disc ROM (CD-ROM).

An example e medium may be coupled to the processor, which may read information from, and write information to, the storage medium. In another method, the storage medium may be integral with the processor. The processor and the storage medium may reside within an application specific integrated circuit (ASIC). The ASIC may reside within a user terminal. In another method, the processor and the storage medium may reside as individual components in the user terminal.

FIGS. 2 to 6 are drawings for describing an operation of a learning device. First of all, referring to FIGS. 2 and 3, the first student neural network 1100 may apply 1_1st neural network operation to a training image to generate first prediction information corresponding to a specific task.

At this time, the first student neural network 1100 may be in a state where it is already trained to have performance of a certain level using a small amount of training datasets (e.g., a second training image) including label information.

For example, the specific task may be a task for outputting a prediction value for each pixel and may be any one of, for example, a segmentation task, a depth estimation task, or an image restoration task. For reference, FIGS. 2 to 10B illustrate the segmentation task as an example of the specific task for convenience of description, but this is only an example for helping understanding. The specific task is not limited to the segmentation task.

Furthermore, the training image may be an unlabeled image.

For example, the first student neural network 1100 may be a Deeplab v3+ network where ResNet-50 is a backbone network. However, this is only an example, and any network of a structure capable of performing the specific task (e.g., the segmentation task) may be the first student neural network 1100.

Furthermore, the 1_1st neural network operation which is applied to the training image by the first student neural network 1100 may include convolution operation.

Meanwhile, the second student neural network 1200 may apply 2_1st neural network operation to the training image to generate second prediction information corresponding to the specific task.

For example, the first student neural network 1100 and the second student neural network 1200 may be Siamese networks, which may share each other's parameters.

Furthermore, the 2_1st neural network operation which is applied to the training image by the second student neural network 1200 may include convolution operation.

Furthermore, the second student neural network 1200 may be in a state where it is trained to have performance of a certain level using a small amount of training datasets including label information.

Furthermore, the first student neural network 1100 and the second student neural network 1200 may be lightweight neural networks which are more simplified in structure than the first teacher neural network 1400 and the second teacher neural network 1500, which will be described below, and are less in the number of parameters than the first teacher neural network 1400 and the second teacher neural network 1500.

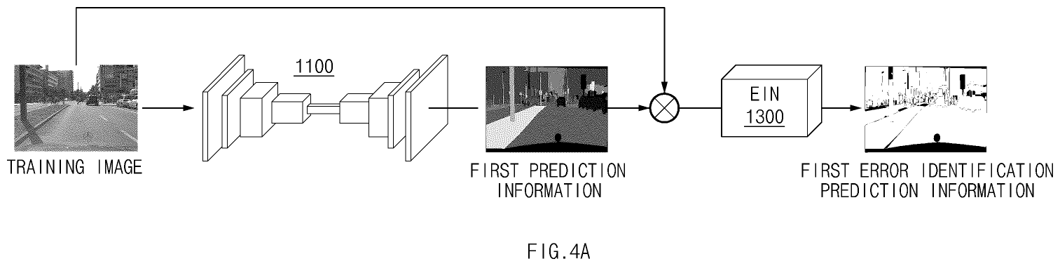

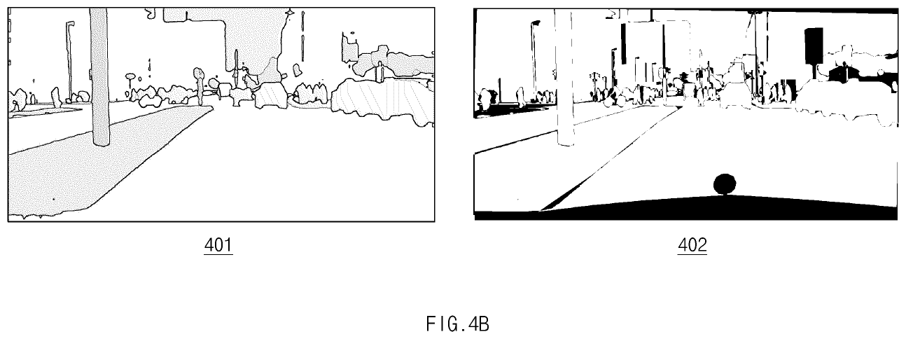

Meanwhile, referring to FIGS. 2 and 4A, an error identification network (EIN) error 1300 may apply identification operation to a first integrated image based on the first prediction information from the first student neural network 1100 and the training image to generate first error identification prediction information for predicting the accuracy of the first prediction information.

Furthermore, the EIN 1300 may apply the error identification operation to a second integrated image based on the second prediction information from the second student neural network 1200 and the training image to generate second error identification prediction information for predicting the accuracy of the second prediction information.

For example, the first integrated image may be generated as concatenation operation is applied to the first prediction information and the training image, and the second integrated image may be generated as concatenation operation is applied to the second prediction information and the training image.

For example, the EIN 1300 may be a network where a pre-trained ResNet34 network is a backbone network in ImageNet and where a sigmoid layer is included in an output stage.

For example, the EIN 1300 may generate a first specific value (e.g., 0.7) within a first certain range corresponding to a first identification value (e.g., 1) as the first error identification prediction information, when the first prediction information is determined as being accurate, and may generate a second specific value (e.g., 0.2) within a second certain range corresponding to a second identification value (e.g., 0) less than the first identification value as the first error identification prediction information, when the first prediction information is determined as being inaccurate.

Similarly, the EIN 1300 may generate a third specific value (e.g., 0.8) within the first certain range as the second error identification prediction information, when the second prediction information is determined as being accurate, and may generate a fourth specific value (e.g., 0.1) within the second certain range as the second error identification prediction information, when the second prediction information is determined as being inaccurate.

For reference, the EIN 1300 may be a network which is already trained using a training dataset including error identification label information.

Referring to FIG. 4B, the learning device 1000 may identify (i) error identification prediction information 401 output from the EIN 1300 and (ii) error identification label information 402 used to train the EIN 1300.

For example, the EIN 1300 may determine accuracy (or a confidence level) for classification information for each pixel as prediction information output by the neural network (e.g., the student neural network). When it is determined that classification information of the neural network for a specific pixel is a correct answer, the error identification prediction information (or error identification prediction information for each pixel) may have a first identification value (e.g., 1) or a value (e.g., 0.8) close to the first identification value. When it is determined that the classification information of the neural network for the specific pixel is an incorrect answer, the error identification prediction information (or error identification prediction information for each pixel) may have a second identification value (e.g., 0) or a value (e.g., 0.1) close to the second identification value. As a result, error identification prediction information including a probability value for each of all pixels may be output.

Furthermore, error identification label information may be used to train the EIN 1300. The error identification label information may include information about whether the classification information for each pixel as the prediction information output by the neural network (e.g., the student neural network) is actually accurate and may be the binary mask map 402 as shown in FIG. 4B. For example, when classification information of the neural network for pixel (10, 20) is incorrect, the error identification label information may have a value of “0” for the pixel. When classification information of the neural network (e.g., the student neural network) for pixel (50, 40) is correct, the identification label information may have a value of “1” for the pixel.

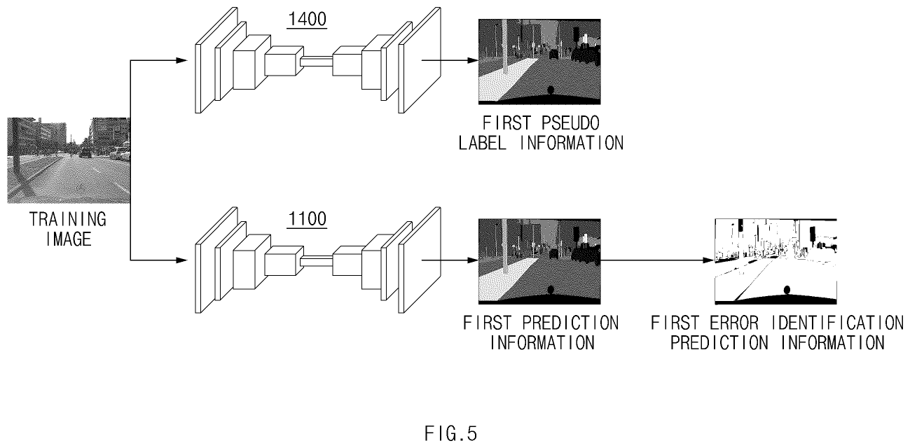

Meanwhile, as shown in FIG. 5, the first teacher neural network 1400 may apply 1_2nd neural network operation to the training image to generate a first pseudo label information corresponding to the specific task. For reference, although the EIN is not illustrated in FIG. 5 for convenience. it may be easily understood that the first integrated image based on the first prediction information and the training image is input to the EIN 1300 and the first error identification prediction information is output.

For reference, because label information is not included in the training image input to the first teacher neural network 1400, the learning device 1000 may regard prediction information (or prediction information corresponding to the specific task for the training image) output from the first teacher neural network 1400 which is pre-trained to have performance of a high level based on a large amount of training data as label information (i.e., first pseudo label information) and may train the first student neural network 1100 using the prediction information.

However, when the learning device 1000 depends on only the first teacher neural network 1400 to train the first student neural network 1100, because there is a problem in which the first student neural network 1100 is trained up to the vulnerability of the first teacher neural network 1400, it may use the above-mentioned EIN 1300 to prevent the problem.

In other words, the EIN 1300 may reflect only information determined as being accurately predicted (or a prediction value corresponding to a specific pixel area) in the first prediction information of the first student neural network 1100 (e.g., classification information for each pixel information), as segmentation prediction which receives knowledge of the first teacher neural network 1400 in the training of the first student neural network 1100. As a result, the learning device 1000 may improve the quality of the first pseudo label information from the first teacher neural network 1400. Only an advantage of each teacher neural network may be transmitted to each student neural network through the above-mentioned process. A detailed learning (e.g., machine learning) process will be described below.

Meanwhile, the second teacher neural network 1500 may apply 2_2nd neural network operation to the training image to generate second pseudo label information corresponding to the specific task.

For example, the first teacher neural network 1400 may be a segmenter network capable of focusing on global contextual information compared to a convolution-based segmentation scheme focusing on a local window. Furthermore, the second teacher neural network 1500 may be an encoder-decoder network which applies depth-wise separable convolution to an atrous spatial pyramid pooling (ASPP) module and a decoder, which may be a deeplabv3+ network with less loss of spatial information because a large receptive field is able to be taken even without performing pooling. However, this is only an example, and the first teacher neural network 1400 and the second teacher neural network 1500 may be networks of different structures capable of performing the specific task (e.g., the segmentation task).

For reference, because the description of the second teacher neural network 1500 is the same as/similar to the description of the first teacher neural network 1400, a duplicated description thereof will be omitted.

Meanwhile, the parameter update device 1600 may back-propagate a first loss based on at least some of the first prediction information, the second prediction information, the first identification prediction information, the second error identification prediction information, the first pseudo label information, or the second pseudo label information and may update parameters of the first student neural network 1100 and the second student neural network 1200.

At this time, the first loss may include a 1_1st loss, a 1_2nd loss, and a 1_3rd loss.

For example, the parameter update device 1600 may back-propagate the 1_1st loss generated based on the first prediction information, the first error identification prediction information, and the first pseudo label information and may update the parameter of the first student neural network 1100.

Furthermore, the parameter update device 1600 may back-propagate the 1_2nd loss generated based on the second prediction information, the second error identification prediction information, and the second pseudo label information and may update the parameter of the second student neural network 1200.

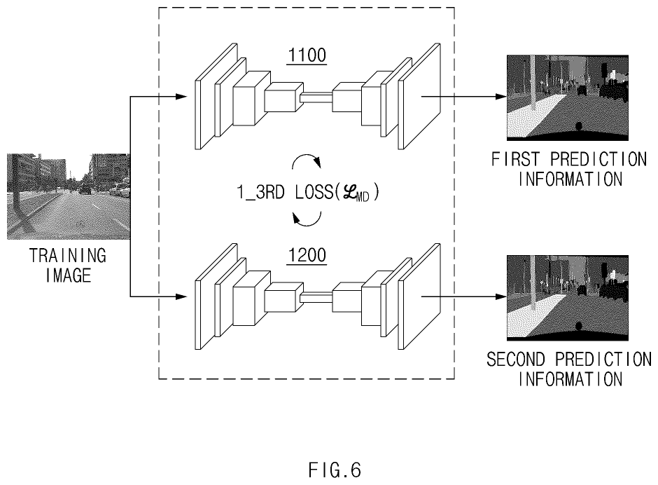

Furthermore, as shown in FIG. 6, the parameter update device 1600 may back-propagate the 1_3rd loss L_{MD} generated based on the first prediction information of the first student neural network 1100 and the second prediction information of the second student neural network 1200 and may update the parameter(s) of the first student neural network 1100 and/or the second student neural network 1200. In other words, consistent information between the respective neural networks may be shared through the 1_3rd loss.

The configuration of the learning device 1000 has been described. A description will be given below of the operation of the learning device 1000.

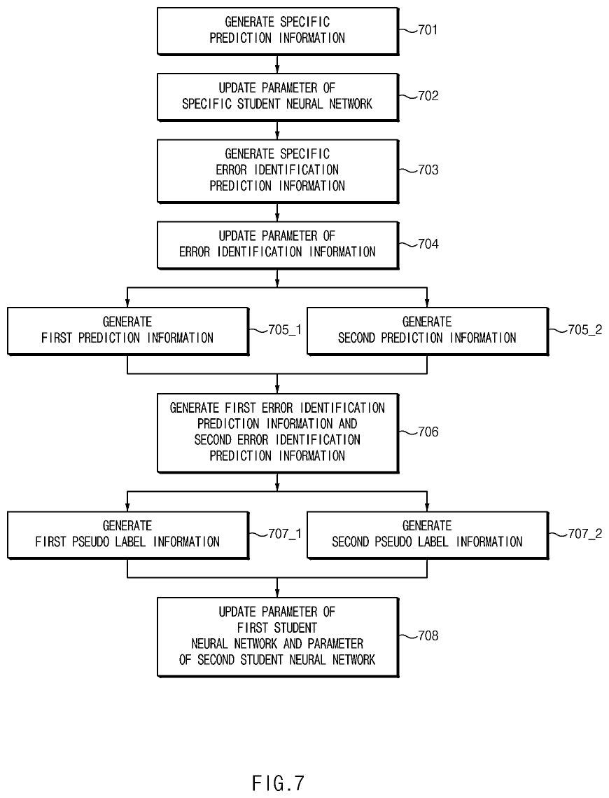

FIG. 7 is a flowchart for describing a learning method. Referring to FIG. 7, in operation 701, at least one specific student neural network between a first student neural network 1100 and a second student neural network 1200 may apply specific neural network operation to a second training image to generate specific prediction information corresponding to a specific task (e.g., a segmentation task, a depth estimation task, an image restoration task, or the like).

For reference, the second training image may include specific label information corresponding to the specific task. For example, the second training image may include label information corresponding to the segmentation task.

In operation 702, a parameter update device 1600 may back-propagate a second loss based on the specific prediction information and the specific label information and may update a parameter of the specific student neural network. In other words, the parameter update device 1600 may perform supervised learning for a student neural network using a small amount of labeled data.

Putting this into a formula, it is as follows.

$${L}_{ce} ( P , Y ) = - {\sum }_{i} {Y}_{i}^{T} log ( {P}_{i} ) \qquad [ Equation 1 ]$$

$${L}_{sup} = \frac{1}{\vert {D}_{L} \vert} {\sum }_{X ∈ {D}_{L}} {L}_{ce} ( P , Y ) \qquad [ Equation 2 ]$$

For reference, D_{L} may denote the training dataset including the second training image, L_{ce} may denote the cross entropy for each standard pixel between the specific prediction information P and the specific label information Y corresponding to it, i may denote the index indicating each pixel of the input, Yᵢ may denote the one-hot vector of the ground truth (GT) of pixel i, T may denote the transpose, and Lₛᵤₚ may denote the second loss as the cross entropy loss.

In operation 703, an EIN 1300 may apply error identification operation to a specific integrated image based on the specific prediction information and the second training image to generate specific error identification prediction information for predicting the accuracy of the specific prediction information.

In operation 704, the parameter update device 1600 may back-propagate a third loss based on the specific error identification prediction information and the specific label information corresponding to the specific error identification prediction information and may update a parameter of the EIN 1300.

As a result, the EIN 1300 may be trained to determine the accuracy of the specific prediction information on a pixel-by-pixel basis.

Putting this into a formula, it is as follows.

$${L}_{EI} = \frac{1}{\vert {D}_{L} \vert} {\sum }_{X ∈ D} {L}_{ce} ( B , M ) \qquad [ Equation 3 ]$$

$$B = EIN ( X ⊕ P )$$

For reference, B may be specific error identification prediction information of the EIN 1300, which may be the result of applying the error identification operation to the result of concatenating a second training image X with specific prediction information P. Furthermore, L_{ce} may denote the cross entropy for each standard pixel between the specific error identification prediction information B and the specific error identification label information M corresponding to the specific error identification prediction information B, and LEI may denote the third loss as the cross entropy loss.

In operation 705_1, the first student neural network 1100 may apply 1_1st neural network operation to a first training image to generate first prediction information corresponding to a specific task.

In operation 705_2, the second student neural network 1200 may apply 2_1st neural network operation to the first training image to generate second prediction information corresponding to the specific task.

In operation 706, the EIN 1300 may apply error identification operation to a first integrated image based on the first prediction information and the first training image to generate first error identification prediction information for predicting the accuracy of the first prediction information and may apply the error identification operation to a second integrated image based on the second prediction information and the first training image to generate second error identification prediction information for predicting the accuracy of the second prediction information.

In operation 707_1, a first teacher neural network 1400 may apply 1_2nd neural network operation to the first training image to generate first pseudo label information corresponding to the specific task.

In operation 707_2, a second teacher neural network 1500 may apply 2_2nd neural network operation to the first training image to generate second pseudo information corresponding to the specific task.

For reference, operations 707_1 and 707_2 are described after the description of operations 705_1 and 705_2 for convenience of description, but an operation order of the learning device 1000 is not limited to the example. For example, operations 707_1 and 707_2 may be performed at the same time as operations 705_1 and 705_2, but may be performed earlier than operations 705_1 and 705_2.

In operating 708, the parameter update device 1600 may back-propagate a first loss based on at least some of the first prediction information, the second prediction information, the first error identification prediction information, the second error identification prediction information, the first pseudo label information, or the second pseudo label information and may update parameters of the first student neural network 1100 and the second student neural network 1200.

For example, the parameter update device 1600 may back-propagate i) a 1_1st loss generated based on the first prediction information, the first error identification prediction information, and the first pseudo label information, (ii) a 1_2nd loss generated based on the second prediction information, the second error identification prediction information, and the second pseudo label information, and (iii) a 1_3rd loss generated based on the first prediction information and the second prediction information as the first loss and may update the parameters of the first student neural network 1100 and the second student neural network 1200.

Putting this into a formula, it is as follows.

$${L}_{pseudo} = - \frac{1}{\vert {D}_{U} \vert} {\sum }_{X ∈ {D}_{U}} {\sum }_{i} ⌊ {B}_{i} ⌋ log ( {P}_{i} ) \qquad [ Equation 5 ]$$

$${L}_{pseudo} = - \frac{1}{\vert {D}_{U} \vert} {\sum }_{X ∈ {D}_{U}} {\sum }_{n = 0}^{N} {\sum }_{i} ⌊ {B}_{i}^{n} ⌋ log ( {P}_{i}^{n} ) \qquad [ Equation 6 ]$$

$${L}_{MD} = - \frac{1}{\vert {D}_{U} \vert} {\sum }_{X ∈ {D}_{U}} {S}^{1} ( \frac{{S}^{1}}{{S}^{2}} ) \qquad [ Equation 7 ]$$

For reference, Du may denote the training dataset (or the unlabeled dataset) including the first training image, L_{pseudo} may denote the 1_1 loss as the loss for each pixel similar to Lₛᵤₚ, B may denote the first error identification prediction information of the EIN, Pᵢ\hat{ }may denote the one-hot vector of the first pseudo label information, i may denote the index for each pixel, └ ┘ may denote the function which rounds to the nearest integer, and L_{MD} may denote the 1_3rd loss generated based on the first prediction information s¹ and the second prediction information s². For example, L_{MD} may denote the Kullback-Leibler divergence (KLD) between the first prediction information s¹ and the second prediction information s². For reference, the KLD (or relative entropy, information gain, or information divergence) may be a function used to calculate a difference between two probability distributions, which may calculate an information entropy difference capable of being generated when performing sampling using another distribution which approximates certain ideal distribution.

When the number of teacher neural networks is plural, it may be arranged as in Equation 6.

As may be seen in Equations 5 and 6, the learning device 1000 described above may use only an area with no error in prediction information of the student neural network for learning, using the error identification prediction information of the EIN 1300.

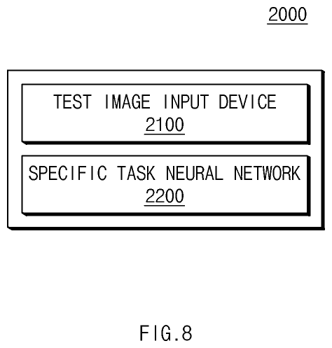

Meanwhile, a description will be given below of the configuration of a test device 2000 including a specific student neural network, a parameter of which is updated, using the learning device 1000 described above with reference to FIG. 8.

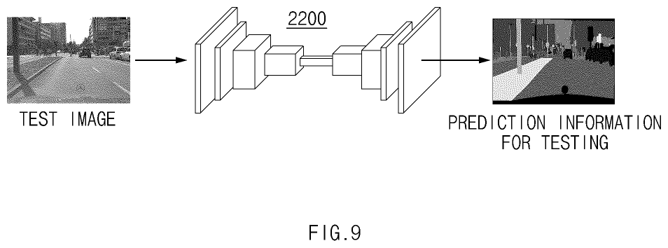

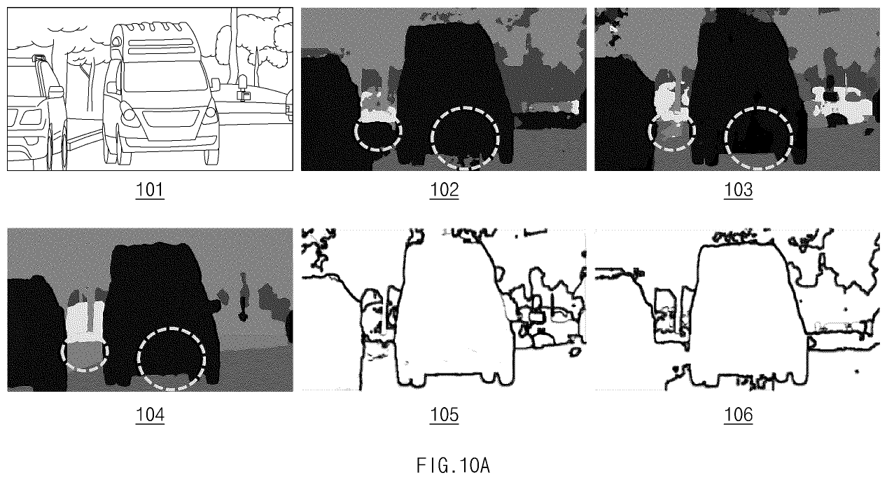

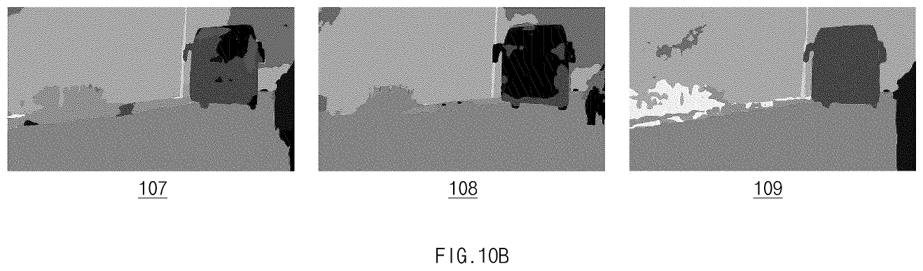

FIG. 8 is a block diagram illustrating a configuration of a test device 2000. FIG. 9 is a drawing for describing an operation of a test device. FIGS. 10A and 10B are drawings comparing an output of a test device with an output of a device.

Referring to FIG. 8, the test device 2000 may include a test image input device 2100 and a specific task neural network 2200 (i.e., a specific student neural network, a parameter of which is updated using a learning device).

First of all, the test image input device 2100 may receive a test image in which label information is not included.

Meanwhile, as shown in FIG. 9, the specific task neural network 2200 may apply specific neural network operation to the test image to generate prediction information for testing, which corresponds to the specific task.

For reference, the specific task neural network 2200 may be any one of a first student neural network or a second student neural network, training of which is performed through the above-mentioned training process.

The two student neural networks and the two teacher neural are as networks described above an example for convenience of description, but the present disclosure is not limited thereto. For example, the same/similar description may be applied to three or more student neural networks and three or more teacher neural networks corresponding to the three or more student neural networks.

(i) an output of an existing single teacher network (teachers A and B) and (ii) an output of a student network based on knowledge distillation using a plurality of teacher neural networks will be compared below with reference to FIGS. 10A and 10B.

First of all, referring to FIG. 10A, it may be identified that the segmentation accuracy of the output of teacher A (e.g., a segmenter) and the output of teacher B (e.g., deeplabv3+) is low for the same test image 101. This may be identified in detail by means of error identification information 105 of teacher A and error identification information 106 of teacher B. However, it is shown that ambulance and car areas are recognized to have a low relative error because teacher A has the advantage of recognizing global contextual information. On the other hand, it may be identified that relatively many errors are discovered in teacher B, but the road behind the ambulance is relatively better recognized in teacher B than that in teacher A.

The performance of a student neural network may be considerably improved using pieces of information with a relative advantage from each teacher neural network. Thus, it may be identified through an output 104 of a student neural network, the training of which is completed.

It may be identified with reference to FIG. 10B.

Referring to FIG. 10B, it may be identified that the accuracy of an output 107 of a teacher (A) neural network and an output 108 of a teacher (B) neural network are inaccurate for the same test image, whereas the accuracy of an output 109 of a specific task neural network included in the test device is very high.

The present technology may provide the learning device for training the student neural network based on the knowledge distillation using the plurality of teacher neural networks, the learning method therefor, the test device using the same, and the test method using the same.

The present technology may provide the learning device for delivering an advantage of each of the plurality of teacher neural networks to the student neural network, the learning method therefor, the test device using the same, and the test method using the same.

The present technology may provide the learning device for reducing costs consumed to construct a training dataset, the learning method therefor, the test device using the same, and the test method using the same.

The present technology may provide the learning device for improving the performance of the student neural network based on the knowledge distillation between the plurality of student neural networks, the learning method therefor, the test device using the same, and the test method using the same.

In addition, various effects ascertained directly or indirectly through the present disclosure may be provided.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the example embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A learning device comprising:
one or more processors; and
memory storing instructions that, when executed by the one or more processors, cause the learning device to:
apply a neural network operation of a first student neural network to a training image to generate first prediction information corresponding to a specific task;
apply a neural network operation of a second student neural network to the training image to generate second prediction information corresponding to the specific task;
apply, based on the first prediction information and the training image, an error identification operation of an error identification network to a first integrated image to generate first error identification prediction information for predicting accuracy of the first prediction information;
apply, based on the second prediction information and the training image, the error identification operation of the error identification network to a second integrated image to generate second error identification prediction information for predicting accuracy of the second prediction information;
apply a neural network operation of a first teacher neural network, associated with the first student neural network, to the training image to generate first pseudo label information corresponding to the specific task;
apply a neural network operation of a second teacher neural network, associated with the second student neural network, to the training image to generate second pseudo label information corresponding to the specific task;
back-propagate, using a parameter update device, a loss based on at least one of: the first prediction information, the second prediction information, the first error identification prediction information, the second error identification prediction information, the first pseudo label information, or the second pseudo label information; and
update, using the parameter update device and based on the loss, parameters of the first student neural network and the second student neural network.

2. The learning device of claim 1, wherein the loss includes a first loss, a second loss, and a third loss, and
wherein the instructions, when executed by the one or more processors, further cause the learning device to:
generate the first loss based on the first prediction information, the first error identification prediction information, and the first pseudo label information;
generate the second loss based on the second prediction information, the second error identification prediction information, and the second pseudo label information; and
generate the third loss based on the first prediction information and the second prediction information.

3. The learning device of claim 1,
wherein the instructions, when executed by the one or more processors, further cause the learning device to perform at least one of:
generating, using the error identification network and based on a determination that the first prediction information is accurate, the first error identification information by determining a first specific value within a first certain range corresponding to a first identification value, or
generating, using the error identification network and based on a determination that the first prediction information is inaccurate, the first error identification prediction information by determining a second specific value within a second certain range corresponding to a second identification value less than the first identification value, and
wherein the instructions, when executed by the one or more processors, further cause the learning device to perform at least one of:
generating, using the error identification network and based on a determination that the second prediction information is accurate, the second error identification prediction information by determining a third specific value within the first certain range, or
generating, using the error identification network and based on a determination that the second prediction information is inaccurate, the second error identification prediction information by determining a fourth specific value within the second certain range.

4. The learning device of claim 1, wherein the instructions, when executed by the one or more processors, further cause the learning device to:
generate the first integrated image with a concatenation operation on the first prediction information and the training image; and
generate the second integrated image with the concatenation operation on the second prediction information and the training image.

5. The learning device of claim 1, wherein the specific task comprises one of: a segmentation task, a depth estimation task, or an image restoration task.

6. A test device comprising:
one or more processors; and
memory storing instructions that, when executed by the one or more processors, cause the learning device to:
apply a first neural network operation of a first student neural network to a training image to generate first prediction information corresponding to a specific task, wherein the first student neural network comprises a specific task neural network;
apply a neural network operation of a second student neural network to the training image to generate second prediction information corresponding to the specific task;
apply, based on the first prediction information and the training image, an error identification operation of an error identification network to a first integrated image to generate first error identification prediction information for predicting of accuracy the first prediction information;
apply, based on the second prediction information and the training image, the error identification operation of the error identification network to a second integrated image to generate second error identification prediction information for predicting accuracy of the second prediction information;
apply a neural network operation of a first teacher neural network, associated with the first student neural network, to the training image to generate first pseudo label information corresponding to the specific task;
apply a neural network operation of a second teacher neural network, associated with the second student neural network, to the training image to generate second pseudo label information corresponding to the specific task;
back-propagate, using a parameter update device, a first loss based on at least one of: the first prediction information, the second prediction information, the first error identification prediction information, the second error identification prediction information, the first pseudo label information, or the second pseudo label information;
update, using the parameter update device and based on the first loss, parameters of the first student neural network and the second student neural network;
receive, using a test image input device, a test image; and
apply a specific neural network operation of the specific task neural network to the test image to generate prediction information for testing, the prediction information corresponding to the specific task.

7. The test device of claim 6, wherein the loss includes a first loss, a second loss, and a third loss, and
wherein the instructions, when executed by the one or more processors, further cause the learning device to:
generate the first loss based on the first prediction information, the first error identification prediction information, and the first pseudo label information;
generate the d loss based on the second prediction information, the second error identification prediction information, and the second pseudo label information; and
generate the third loss based on the first prediction information and the second prediction information.

8. The test device of claim 6,
wherein the instructions, when executed by the one or more processors, further cause the learning device to perform at least one of:
generating, using the error identification network and based on a determination that the first prediction information is accurate, the first error identification information by determining a first specific value within a first certain range corresponding to a first identification value, or
generating, using the error identification network and based on a determination that the first prediction information is inaccurate, the first error identification prediction information by determining a second specific value within a second certain range corresponding to a second identification value less than the first identification value, and
wherein the instructions, when executed by the one or more processors, further cause the learning device to perform at least one of:
generating, using the error identification network and based on a determination that the second prediction information is accurate, the second error identification prediction information by determining a third specific value within the first certain range, or
generating, using the error identification network and based on a determination that the second prediction information is inaccurate, the second error identification prediction information by determining a fourth specific value within the second certain range.

9. The test device of claim 6, wherein the instructions, when executed by the one or more processors, further cause the learning device to:
generate the first integrated image with a concatenation operation on the first prediction information and the training image; and
generate the second integrated image with the concatenation operation on the second prediction information and the training image.

10. The test device of claim 6, wherein the specific task comprises one of: a segmentation task, a depth estimation task, or an image restoration task.

11. A method comprising:
applying a neural network operation of a first student neural network to a first training image to generate first prediction information corresponding to a specific task;
applying a neural network operation of a second student neural network to the first training image to generate second prediction information corresponding to the specific task;
applying, based on the first prediction information and the training image, an error identification operation of an error identification network to a first integrated image to generate first error identification prediction information for predicting accuracy of the first prediction information;
applying, based on the second prediction information and the training image, the error identification operation of the error identification network to a second integrated image to generate second error identification prediction information for predicting accuracy of the second prediction information;
applying a neural network operation of a first teacher neural network, associated with the first student neural network, to the first training image to generate first pseudo label information corresponding to the specific task;
applying a neural network operation of a second teacher neural network, associated with the second student neural network, to the first training image to generate second pseudo label information corresponding to the specific task;
back-propagating, using a parameter update device, a loss based on at least one of: the first prediction information, the second prediction information, the first error identification prediction information, the second error identification prediction information, the first pseudo label information, or the second pseudo label information; and
updating, using the parameter update device and based on the loss, parameters of the first student neural network and the second student neural network.

12. The method of claim 11, wherein the updating of the parameters comprises:
back-propagating, using the parameter update device, the loss by:
generating a first loss based on the first prediction information, the first error identification prediction information, and the first pseudo label information;
generating a second loss based on the second prediction information, the second error identification prediction information, and the second pseudo label information; and
generating a third loss based on the first prediction information and the second prediction information.

13. The method of claim 11, further comprising one of:
generating, using the error identification network and based on a determination that the first prediction information is accurate, the first error identification information by determining a first specific value within a first certain range corresponding to a first identification value, or
generating, using the error identification network and based on a determination that the first prediction information is inaccurate, the first error identification prediction information by determining a second specific value within a second certain range corresponding to a second identification value less than the first identification value,
wherein the method further comprises one of:
generating, using the error identification network and based on a determination that the second prediction information is accurate, the second error identification prediction information by determining a third specific value within the first certain range, or
generating, using the error identification network and based on a determination that the second prediction information is inaccurate, the second error identification prediction information by determining a fourth specific value within the second certain range.

14. The method of claim 11, wherein one of the first student neural network or the second student neural network is a specific student neural network, and
wherein the method further comprises, before generating the first prediction information and the second prediction information:
applying, using the specific student neural network, a specific neural network operation to a second training image including specific label information corresponding to the specific task to generate specific prediction information corresponding to the specific task;
back-propagating, using the parameter update device, a second loss based on the specific prediction information and the specific label information; and
updating, using the parameter update device and based on the second loss, a parameter of the specific student neural network.

15. The method of claim 14, further comprising, after updating the parameter of the specific student neural network:
applying, using the error identification network and based on the specific prediction information and the second training image, the error identification specific integrated image to generate specific error identification prediction information for predicting accuracy of the specific prediction information; and
back-propagating, using the parameter update device, a third loss based on the specific error identification prediction information and specific error identification label information corresponding to the specific error identification prediction information; and
updating, using the parameter update device, a parameter of the error identification network.
